(19) United States
(12) Patent Application Publication
(10) Pub. No.: US 2024/0060910 A1
(43) Pub. Date: Feb. 22, 2024

(54) DEVICE AND METHOD FOR MEASURING A NEUTRON ABSORBER IN A FLUID

(71) Applicant: COMMISSARIAT A L'ENERGIE ATOMIQUE ET AUX ENERGIES ALTERNATIVES, Paris (FR)

(72) Inventors: Adrien SARI, Gif-sur-Yvette Cedex (FR); Nouhaila TABTI, Gif-sur-Yvette Cedex (FR)

(73) Assignee: COMMISSARIAT A L'ENERGIE ATOMIQUE ET AUX ENERGIES ALTERNATIVES, Paris (FR)

(21) Appl. No.: 18/260,439

(22) PCT Filed: Jan. 3, 2022
(86) PCT No.: PCT/EP2022/050037

§ 371 Date: Jul. 5, 2023

(30) Foreign Application Priority Data
Jan. 5, 2021 (FR) FR2100066

(51) Int. Cl. G01N 23/09; G01N 23/02; G01N 23/12; G01T 7/00; G01T 3/00

(52) U.S. Cl. CPC G01N 23/09; G01N 23/025; G01N 23/12; G01T 7/005; G01T 3/00; G21C 17/022

(57) ABSTRACT

A method for determining a concentration of an isotope in a fluid, the isotope absorbing neutrons, the method comprising placing a plurality of neutron detectors at various distances from the fluid; irradiating the fluid by a neutron-emitting source, the latter being placed so that emitted neutrons pass through the fluid before reaching the detectors; measuring, by each detector, a quantity representative of an amount of neutrons reaching the detector; and based on the measurements resulting from the measuring, estimating a concentration of the isotope in the fluid. Further, the estimating step includes taking into account a database containing an estimate of the quantity measured by each detector and based on the database, and on the measurements resulting from the measuring step, estimating the concentration of the isotope in the fluid.

### TECHNICAL FIELD

The technical field of the invention is measurement of a neutron absorber in a fluid, one application targeted being determination of the boron concentration (or the concentration of any other absorbent isotope) in the water of the primary circuit of a nuclear reactor.

### PRIOR ART

In a water-cooled nuclear reactor, reactivity must be controlled in order to prevent occurrence of criticality. The reactivity in the primary circuit is adjusted by adding an isotope having a high neutron absorption. Such an absorbing isotope may be ¹⁰B, which is added to the water in the form of boric acid.

In pressurized water reactors, the boron concentration in the water of the primary circuit is adjusted by means of a chemical and volume control system that is usually designated by the acronym CVCS. The boron concentration may be increased or decreased by adding borated water (water containing boric acid) or demineralized water. The CVCS circuit is an auxiliary circuit of the primary circuit.

The boron concentration in the primary circuit is an important control parameter of nuclear reactors. To this end, devices for measuring boron concentration, designated “boron meters”, are used. These devices are based on the absorption of neutrons by boron. A neutron source irradiates a duct, usually in the CVCS circuit. A neutron detector is placed in proximity to the duct. The detector is positioned so as to be exposed to neutrons emitted by the source, and having passed through the duct before interacting with the detector. The higher the boron concentration in the primary circuit, the higher the neutron absorption in the primary circuit, and the smaller the amount of neutrons detected by the detector.

Generally, a layer of a moderating material lies between the detector and the duct. This is called the moderating layer. This makes it possible to thermalize the neutrons before their detection by the detector. By thermalize, what is meant is slowing down the neutrons, so that their energy reaches an energy range corresponding to thermal neutrons: typically less than 1 eV, for example a few tens or hundreds of meV (millielectronvolts), for example 25.3 meV at room temperature. Specifically, it is in such an energy range that conventional neutron detectors, for example proportional counters, are the most effective.

Based on the amount of neutrons detected by a detector, it is possible to estimate the boron concentration in the primary circuit, using a calibration function. However, the calibration function varies as a function of temperature. Specifically, the absorption cross section of the neutrons, in the water of the primary circuit, just as in the moderating layer or in the detector, varies as a function of temperature.

To address this problem, the neutron measurement, resulting from the neutron detector, may be coupled with a temperature measurement, so as to readjust the calibration function. Such a solution is for example described in U.S. Pat. No. 3,898,467. However, such compensation for the effect of temperature leads to uncertainties, in particular in the representativeness of the measured temperature. This is especially true given that the temperature is not uniform: it is generally high in the vicinity of the duct, then decreases with distance from it, according to a temperature gradient.

The inventors provide a device and method allowing an estimation of a boron concentration in a fluid, without requiring an independent temperature measurement and compensation of the calibration function. The invention allows the temperature of the fluid to be taken into account, but also a potential variation in temperature in the moderating layer, between the fluid and at least one neutron detector. Temperature notably varies in the moderating layer when the latter is solid.

### SUMMARY OF THE INVENTION

A first subject of the invention is a method for determining a concentration of an isotope in a fluid, the isotope being able to absorb neutrons, the method comprising:
a) placing a plurality of neutron detectors respectively at various distances from the fluid, the detectors forming a group of detectors;
b) irradiating the fluid by means of a neutron-emitting source, the neutron-emitting source being placed so that neutrons emitted by the source pass through the fluid before reaching the detectors;
c) measuring, by means of each detector of the group of detectors, a quantity representative of an amount of neutrons reaching the detector;
d) based on the measurements resulting from c), estimating a concentration of the isotope in the fluid;
   the method being characterized in that step d) comprises:
di) taking into account a calibration database, the calibration database containing an estimate of the quantity measured by each detector,
   for at least one concentration of the isotope in the fluid;
   and for various spatial temperature distributions through the group of detectors;
dii) based on the calibration database, and on the measurements resulting from c), estimating the concentration of the isotope in the fluid.

The fluid may be water.

According to one embodiment:
step c) comprises forming a measurement set containing the quantities measured by each detector, the size of the measurement set corresponding to the number of detectors in the group of detectors;
step di) comprises, for the or each isotope concentration, and for each temperature distribution, forming a calibration set containing estimates of quantities measured by each detector, the size of each calibration set corresponding to the number of detectors of the group of detectors, each calibration set being associated with a concentration of the isotope and with a spatial temperature distribution across the group of detectors;
step dii) comprises implementing an optimization algorithm, so as to select, among the various calibration sets, the calibration set closest to the measurement set, the estimated isotope concentration corresponding to the isotope concentration associated with the selected calibration set.

In step di) the calibration sets may be formed for various temperatures of the fluid, such that each estimation set is associated with one temperature of the fluid.

According to one embodiment:
the group of detectors is placed in an exterior medium, such as air, at an exterior temperature;
in step di) the calibration sets are formed for various exterior temperatures, such that each calibration set is associated with one exterior temperature.

The fluid may lie in a duct, the detectors being placed around the duct. According to one possibility:
the fluid flows through the duct at a flow rate;
in step di), the calibration sets are formed for various flow rates of fluid through the duct, such that each calibration set is associated with one flow rate of the fluid.

The quantity measured by each detector may be:
a count rate of neutrons detected by the detector;
a number of neutrons incident on the detector per unit time and optionally per unit area.

A layer of a moderating material may be interposed between each detector and the fluid, the thickness of the layer being different for each detector. The layer of the moderating material may be divided into elementary layers, each detector lying in one elementary layer, the spatial temperature distribution corresponding to a temperature of each elementary layer.

The isotope may be ¹⁰B or ⁶Li.

A second subject of the invention is a device for estimating a concentration of an isotope in a fluid, the fluid lying in an enclosure, the isotope being able to absorb neutrons, the device comprising:
a neutron-emitting source;
a plurality of neutron detectors, arranged to be respectively placed at various distances from the enclosure, and forming a group of detectors;
the neutron source being placed so that some of the neutrons emitted by the source pass through the fluid before reaching the detectors;
a processing unit that is connected to the detectors and configured to implement step d) of the method according to the first subject of the invention based on measurements, taken by each detector of the group of detectors, of a quantity representative of an amount of neutrons reaching the detector.

According to one embodiment, a layer of a moderating material lies around each detector, so that the thickness of the layer, between the detector and the enclosure, is different for each detector. The layer may be formed from various moderating materials.

The invention will be better understood on reading the description of the examples of embodiment that are presented, in the rest of the description, with reference to the figures listed below.

### FIGURES

FIGS. 1A to 1D show one example of a device allowing the invention to be implemented.

FIG. 2 shows a spectrum of neutrons thermalized by a moderating material raised to various temperatures.

FIG. 3 schematically shows the main steps of a method according to the invention.

FIG. 4 shows another example of a device allowing the invention to be implemented.

### DESCRIPTION OF PARTICULAR EMBODIMENTS

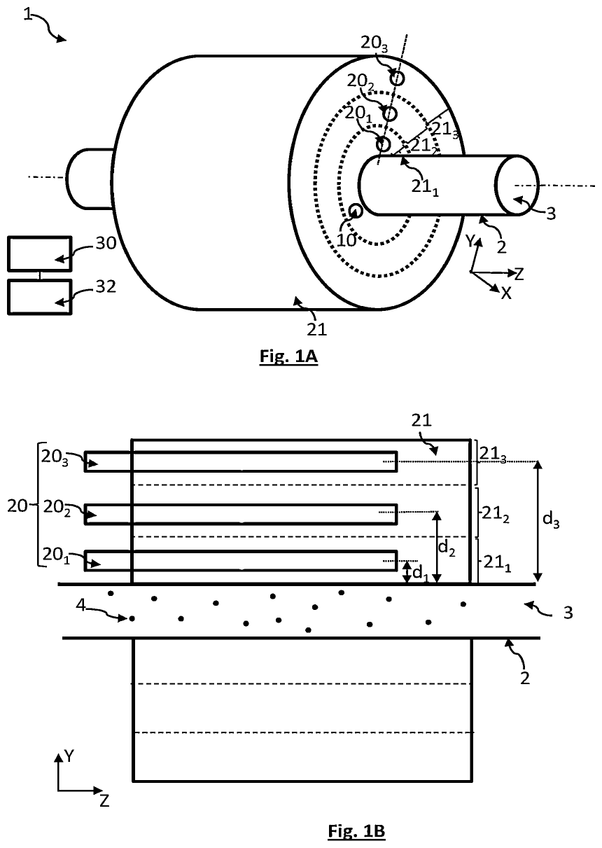

FIGS. 1A to 1D show one example of a device 1 according to the invention. The device 1 is arranged to be placed beside an enclosure 2 in which a heat-transfer fluid 3 lies. The device 1 is intended to estimate a concentration of an isotope 4 in the heat-transfer fluid 3. The isotope 4 is a neutron-absorbing isotope. In this example, the isotope is ¹⁰B though it could be another isotope, ⁶Li for example. In this example, the heat-transfer fluid 3 is borated water (mixture of water and boric acid) and the enclosure 2 is a borated-water duct. The duct extends along a longitudinal axis Z. In other applications, the fluid is contained in a tank. The longitudinal axis Z is perpendicular to a radial plane, the latter being defined by a first radial axis X and a second radial axis Y.

The device comprises a neutron source 10. It may be an isotopic source, comprising one or more isotopes, allowing emission of neutrons. In this example, the isotopic source is an Am/Be source, the neutron emission of which is based on an (α, n) reaction. Other types of sources, based on the same principle, are envisionable, for example ²⁴¹Am/Li or ²⁴⁴Cm/Be. The neutron source 10 may be a spontaneous-fission source, the most common isotopes being ²⁵²Cf or ²⁴²Cm.

The device 1 comprises three neutron detectors 20₁, 20₂, 20₃, forming a group of detectors 20. The number of neutron detectors forming the group of detectors 20 is not limited to three. More generally, as described below, the device comprises a group of detectors 20 containing I neutron detectors 20₁ . . . 20ᵢ . . . 20_{I}. The number I of neutron detectors is preferably comprised between 2 and 20. The index i is an integer designating a rank of each detector. In the example described, the higher the rank i, the further the detector is from the neutron source 10 and from the enclosure 2. In this example, the detectors are aligned along the second radial axis Y.

FIG. 1B shows a cross-sectional view of the device, in a YZ-plane passing through the center of the duct 2. The neutron detectors 20ᵢ are placed at various distances from the neutron source 10 and/or at various distances from the enclosure 2 containing the fluid. Each neutron detector 20, lies at a distance di from the enclosure 2, and at a distance rᵢ from the neutron source 10. The distances dᵢ or rᵢ may for example be comprised between 1 cm and 50 cm. The distances d₁, d₂ and d₃ separating the first, second and third detectors from the enclosure 2 have been shown in FIG. 1B, respectively.

Each detector 20ᵢ is configured to detect an amount of neutrons TCᵢ emitted by the neutron source 10, some of which propagated through the borated water 3 before reaching the detector 20ᵢ. The amount of neutrons TCᵢ detected by each detector 20ᵢ depends on the concentration C of the absorbing isotope in the fluid 3. It will be understood that as concentration C increases the amount of neutrons TCᵢ detected by each detector 20ᵢ decreases.

The amount of neutrons TCᵢ detected by each detector 20ᵢ is usually expressed in the form of a count rate, i.e. a number of neutrons detected per unit time. The count rate depends directly on an amount of neutrons ϕᵢ incident on the detector, and on the energy of the neutrons incident on the detector. The amount of neutrons ϕᵢ incident on the detector is expressed:
in the form of a number of neutrons per unit time (neutrons per second for example);
or in the form of a fluence rate: number of neutrons per unit time and unit area (neutrons per second per cm² for example).

The relationship between the amount of incident neutrons ϕᵢ and the detected amount of neutrons TCᵢ corresponds to a detection efficiency εᵢ of the detector 20ᵢ:

TCᵢ=εᵢ(ϕᵢ) (1)

In this example, each detector 20ᵢ is a boron-lined proportional counter. This type of counter is conventional. Under the effect of irradiation with a neutron flux, charged particles (α) are formed in the gas via (n,α) capture. The α particles are detected by biased electrodes. This results in a count rate TCᵢ.

Boron-lined proportional counters have a better detection efficiency when the energy of the neutrons is low, typically in the thermal range, as mentioned in the prior art. In order to decrease the energy of the neutrons, a moderating layer 21 is interposed between each detector 20ᵢ and the enclosure 2. The moderating layer is formed from a neutron-scattering material: it is a question of thermalizing the neutrons, i.e. of slowing them down, so that their energy decreases. Use of such a moderating layer is conventional in the field of neutron detection. The moderating layer may comprise a material that scatters neutrons strongly, polyethylene for example. It may also be graphite, or a composite formed from a superposition of moderating materials.

Each counter is connected to a processing unit 30 by a wired or wireless link. The processing unit 30 may comprise a microprocessor. The processing unit 30 is programmed to estimate a concentration of ¹⁰B in the fluid 3 based on the count rate TCᵢ respectively measured by each detector 20ᵢ. The processing unit comprises a memory 32, in which are stored instructions allowing the amount of ¹⁰B in the fluid to be estimated.

FIGS. 1C and 1D show a cross section of the device 1 in an XZ-plane passing through the neutron source 10, and a cross section of the device 1 in a radial XY-plane passing through the source and each detector, respectively. The distances r₁, r₂ and r₃ separating the first, second and third detectors from the source 10 have been shown in FIG. 1D, respectively.

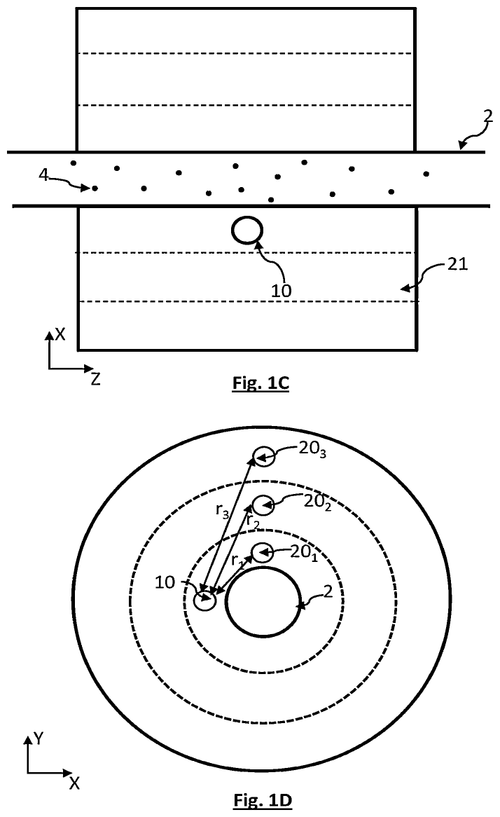

FIG. 2 shows spectra of neutrons, thermalized by a moderating material (e.g. water or polyethylene or graphite), for various temperatures. In FIG. 2, the x-axis is energy (meV—millielectronvolts) and the y-axis is a neutron flux normalized by a neutron density (unit ms-1.ev-1). FIG. 2 was obtained by applying the following analytical expression:

$$Φ ( E ) = {n}_{0} \frac{2 π}{{( π kT )}^{3 / 2}} {( \frac{2}{m} )}^{1 / 2} {Ee}^{( - \frac{E}{kT} )} \qquad ( 2 )$$

where
Φ(E) is a flux of neutrons at an energy E (·cm⁻²·J⁻¹·s⁻¹);
n₀ is a neutron density in cm⁻³;
k is Boltzmann's constant (J·K⁻¹);
m is the mass of a neutron (kg);
E is energy (J);
T is temperature (K).

In FIG. 2, the curve

$$\frac{Φ ( E )}{{n}_{0}}$$

has been shown for the following temperatures: 20° C., 38° C., 56° C., 77° C., 127° C.

It may be seen that as temperature increases the relative proportion of high-energy neutrons also increases. This corresponds to a hardening of the energy spectrum of the neutrons.

Now, for thermal neutrons, the capture cross section of a moderating material varies as a function of energy: as energy increases capture cross section decreases. Table 1 shows, for various temperatures, and for energies in the vicinity of 25 meV, the respective neutron capture cross sections of:
¹²C: (n,γ) reaction;
¹H: (n,γ) reaction;
¹⁰B: (n,α) reaction;

The energies at which the cross sections (unit millibarns) were computed correspond to the maximum value of the spectra shown in FIG. 2, for the temperatures of 20° C., 38° C. and 56° C.

TABLE 1

| T (° C.) | T (K) | E (eV) | ¹²C | ¹H | ¹⁰B |
|---|---|---|---|---|---|
| 20 | 293 | 0.0253 | 3.861 | 332.128 | 3843.526 |
| 38 | 311 | 0.002684 | 3.749 | 322.437 | 3731.345 |
| 56 | 329 | 0.028387 | 3.645 | 313.547 | 3628.442 |

Table 1 shows a decrease in capture cross section for each energy corresponding to the maximum value. Thus, because it causes spectrum hardening, an increase in temperature decreases the neutron absorption capacity of the water, of the moderating cover 21 (polyethylene) and of the material forming the boron-lined proportional detector. This results in a decrease in the efficiency of the device, in the sense that the amount of detected neutrons decreases for a given amount of ¹⁰B in the water.

The same observation may be made when other types of detectors sensitive to thermal or epithermal neutrons are used, for example a fission chamber (the absorbing material is then ²³⁵U or ²³⁹Pu) or a ³He proportional counter.

The invention allows the question of the sensitivity of the measurements to temperature to be addressed, without requiring recourse to one or more temperature sensors. The invention also takes into account the fact that the temperature may vary between the borated water 3 and the various detectors 20ᵢ. As indicated above, the temperature is maximum at the duct 2, and decreases with distance therefrom. One source of uncertainty is the fact that the temperature within the moderating layer is generally not uniform: a, more or less marked, decreasing temperature gradient may exist between the duct 2 and the various detectors 20ᵢ. It is difficult to envision measuring this gradient by means of temperature sensors distributed through the moderating cover.

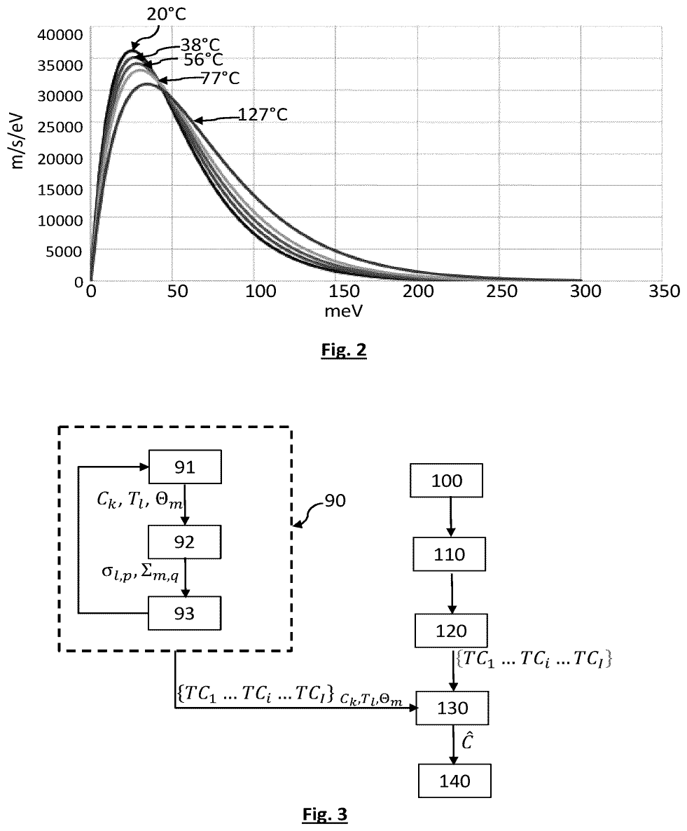

FIG. 3 shows the main steps of a method for determining a concentration of ¹⁰B by implementing a device such as described above.

The method assumes a prior calibration phase, which corresponds to the step 90. The objective of the calibration is to estimate, for each detector 20ᵢ of the group of detectors 20, a quantity representative of an amount of neutrons reaching the detector, under various conditions. The estimated quantity is a count rate TCᵢ measured by each detector (number of neutrons detected per second). According to another possibility, the estimated quantity is a number of neutrons Nᵢ incident on the detector per unit time or a number of neutrons Φi incident on the detector per unit time and unit area (particle flux density). The relationship between the count rate TCᵢ and the number of neutrons incident on the detectors per unit time (Nᵢ or Φᵢ) depends on the efficiency εi of the detector 20ᵢ.

For each detector 20ᵢ, the count rate TCᵢ is estimated using a computer code modeling neutron transport. It may for example be a question of the computer code MCNP6, which is based on a Monte-Carlo method. During the calibration phase, simulations are carried out taking into account:
a predetermined concentration of ¹⁰B,
and various spatial distributions of absorption and scatter cross sections between the duct 2 and the detectors 20ᵢ.

Each spatial distribution of absorption cross sections corresponds to one spatial temperature distribution. Considering various spatial distributions of absorption cross sections allows the response of the device to be simulated for various temperature distributions between the duct 2 and the detectors 20ᵢ.

To this end, the moderating layer 21 is divided into a plurality of elementary layers 21ⱼ virtually. The index j is an integer representing the rank of each layer. In FIGS. 1A to 1D, three elementary layers 21₁, 21₂, 21₃ have been shown, each layer lying on either side of one detector. In other words, in this example i=j. In other configurations, the number J of elementary layers in question may be lower or higher than the number I of detectors. J corresponds to an increment of discretization of the temperature gradient.

The calibration phase consists in estimating the count rates TCᵢ measured by each detector for various sets of input parameters. Each set of input parameters contains:
a boron concentration in the fluid;
an absorption cross section in the fluid, which corresponds to a temperature of the fluid T;
a spatial distribution of absorption cross sections for the various elementary layers 21ⱼ and in the various detectors 20ᵢ, which is representative of a spatial distribution of the temperature between the duct and the various detectors.

A plurality of simulations are carried out while varying:
the boron concentration in the fluid
for the same boron concentration, the spatial distribution of the temperature between the various detectors.

It is also possible to vary, fora given boron concentration, the temperature of the borated water, one absorption cross section (¹H and ¹⁰B) being considered at each temperature.

Each modeling operation results in a set of modeled quantities, which are, in this example, the estimates of the resulting count rates TCᵢ of each detector 20ᵢ. Thus, each modeling operation generates a set {TC₁ . . . TCᵢ . . . TC_{I}}_{C}_{ₖ}_{,T}_{ₗ}_{,Θ}_{ₘ} of I respective count rates of each detector 20ᵢ. Each modeled set is associated with the modeling parameters, which are:
the boron concentration Cₖ in the fluid, the index k designating each modeled concentration;
the temperature Tₗ of the water, the index l designating each modeled concentration. Each temperature corresponds to one or more cross sections σ_{l,p} of absorbent elements present in the water, in the present case ¹H and ¹⁰B. The index p designates each absorbent element in question in the water.
the spatial temperature distribution Θₘ in each layer 21ⱼ. The index m designates each modeled spatial temperature distribution.

By spatial temperature distribution, what is meant is a distribution of the temperature in the various elementary layers 21ⱼ lying between the duct 2 and the detectors 20ᵢ: Θₘ={T₁ . . . Tⱼ . . . T_{J}}ₘ. Based on a spatial temperature distribution Θₘ, a spatial distribution of cross sections Σ_{m,q}={σ_{1,q} . . . σ_{j,q} . . . σ_{J,q}}ₘ of the scattering materials q forming each elementary layer or each detector present in the elementary layer is determined. σ_{j,q} corresponds to a cross section of each absorbent material in the layer 21ⱼ. It may for example be a question of ¹H (present in polyethylene) and of ¹⁰B (present in the detectors). The index q designates each absorbent material in question in an elementary layer.

The calibration step 90 may be summarized as follows:
Sub-step 91: determining input data: boron concentration Cₖ, temperature of the fluid Tₗ, spatial temperature distribution Θₘ.
Sub-step 92: determining:
   the cross sections σ_{l,p} of each absorbent material p in the water at the water temperature Tₗ in question.
   a spatial distribution of cross sections Σ_{m,q} of each scattering material of each elementary layer 21ⱼ, for each temperature in question of each elementary layer.
Sub-step 93: estimating the count rates {TC₁ . . . TCᵢ . . . TC_{I}}_{C}_{ₖ}_{,T}_{ₗ}_{,Θ}_{ₘ} in each detector, corresponding to the modeling data taken into account.

More generally, the sub-step 93 aims to estimate a quantity representative of an amount of neutrons reaching each detector 20ᵢ. As described above, it may be a question of count rate TCᵢ, or of a number of incident neutrons per unit time or of a number of incident neutrons per unit time and unit area.

For a given boron concentration Cₖ, the sub-steps 91 to 93 are implemented at least for various spatial distributions Θₘ and optionally for various water temperatures Tₗ. The sub-steps 91 to 93 may be implemented for various boron concentrations Cₖ.

If K, L and M correspond to the numbers of concentrations Cₖ, temperatures Tₗ and temperature distributions Θₘ in question, respectively, the calibration phase provides K×L×M sets of count rates {TC₁ . . . TCᵢ . . . TC_{I}}_{C}_{ₖ}_{,T}_{ₗ}_{,Θ}_{ₘ}, these sets also being designated calibration sets. The calibration sets {TC₁ . . . TCᵢ . . . TC_{I}}_{C}_{ₖ}_{,T}_{ₗ}_{,Θ}_{ₘ} are stored in the memory 32 connected to the processing unit 30.

The calibration sets result from modeling of neutron transport for discrete values of Cₖ, Tₗ and Θₘ. It is possible to complete the calibration with count rates resulting from interpolations, for example between two different water temperatures Tₗ and Tₗ₊₁. To perform the interpolations, a nuclear data processing code, for example the NJOY code developed by Los Alamos National Laboratory, will possibly be used. Thus, the database resulting from the calibration contains modeled calibration sets {TC₁ . . . TCᵢ . . . TC_{I}}_{C}_{ₖ}_{,T}_{ₗ}_{,Θ}_{ₘ} and potentially calibration sets interpolated based on modeled calibration sets.

In a complementary or alternative way, the database may be established experimentally, for example using a mock-up, and taking into account various water temperatures, various boron concentrations, various spatial temperature distributions between various detectors and various exterior temperatures. By exterior temperature, what is meant is an air temperature, outside the measurement system formed by the various detectors and the moderating layer. Specifically, the temperature of the moderating layer, and the temperature gradient through the moderating layer, depend on the water temperature and on the temperature of the air in which the measurement system lies. The exterior temperature (air temperature) may then form an additional parameter to be taken into account in the database.

During the calibration, on the mock-up, the exterior temperature may be adjusted by regulating the air temperature around the mock-up. The water temperature may be regulated by a thermostat and a water-heating system.

Following the calibration, steps 100 to 140, which allow the concentration of 10B in the water to be estimated, are implemented.

Step 100: irradiating

In this step, the neutron source 10 emits neutrons. Some of the neutrons propagate through the water 3 before reaching the group of detectors 20.

Step 110: measuring, by means of each detector, a quantity representative of an amount of neutrons reaching the detector. In this example, it is the count rate TCᵢ.

Step 120: forming a set of count rates measured by each detector 20ᵢ of the group of detectors 20, respectively. A measured set is thus formed, which set is designated {TC₁ . . . TCᵢ . . . TC_{I}}.

Step 130: taking into account the database resulting from the calibration to determine the calibration set {TC₁ TCᵢ . . . TC_{I}}_{C}_{ₖ}_{,T}_{ₗ}_{,Θ}_{ₘ} closest to the measured set {TC₁ . . . TCᵢ . . . TC_{I}}. For example, a mean difference e_{C}_{ₖ}_{,T}_{ₗ}_{,Θ}_{ₘ} between the measured set {TC₁ . . . TCᵢ . . . TC_{I}} and each calibration set {TC₁ . . . TCᵢ . . . TC_{I}}_{C}_{ₖ}_{,T}_{ₗ}_{,Θ}_{ₘ} may be computed. The mean difference may, for example, be a sum of the absolute values of the differences between the count rates respectively measured and calibrated for a given detector:

$${e}_{{C}_{k} , {T}_{l} , {Θ}_{m}} = {\sum }_{i = 1}^{I} \vert {TC}_{i} - {TC}_{{i}_{{C}_{k} , {T}_{l} , {Θ}_{m}}} \vert \qquad ( 3 )$$

The calibration set {TC₁ . . . TCᵢ . . . TC_{I}}_{C}_{ₖ}_{,T}_{ₗ}_{,Θ}_{ₘ} closest to the measured set is the one minimizing e_{C}_{ₖ}_{,T}_{ₗ}_{,Θ}_{ₘ}.

Step 140: estimating the boron concentration: the estimated boron concentration Ĉ corresponds to the concentration Cₖ of the calibration set {TC₁ . . . TCᵢ . . . TC_{I}}_{C}_{ₖ}_{,T}_{ₗ}_{,Θ}_{ₘ} considered, in the phase 130, to be closest to the measured set {TC₁ . . . TCᵢ . . . TC_{I}}.

Although this is not the sought-after objective, the method also makes it possible to obtain an estimate \hat{T} of water temperature, and an estimate \hat{Θ} of the spatial temperature distribution between the various detectors, with

$$\hat{C} , \hat{T} , \hat{Θ} = {arg min}_{{C}_{k} , {T}_{l} , {Θ}_{m}} ( {e}_{{C}_{k} , {T}_{l} , {Θ}_{m}} ) \qquad ( 4 )$$

Expression (4) allows Ĉ to be estimated.

Step 130 may be implemented using an optimization algorithm, for example an ML-EM method (ML-EM standing for Maximum-Likelihood Expectation Maximization).

One important aspect of the invention is that temperature, whether it be a question of the temperature of the water or of the various elementary layers 21ⱼ, is not an input datum allowing the sought-after concentration to be estimated. It is rather an output datum. The optimization algorithm determines the temperature of the fluid and the spatial temperature distribution, between the various detectors, that best corresponds to the measurements taken by the various detectors.

Advantageously, during the calibration phase, each calibration set is associated with a water flow rate Q and/or with the exterior temperature mentioned above. In this case, the calibration phase is preferably experimental, being carried out on a mock-up. A plurality of water flow rates may be considered in the calibration, and likewise a plurality of exterior-temperature levels. Thus, the database contains, in addition to the parameters Cₖ, Tₗ, Θₘ, a parameter T′ₙ (air temperature) and/or a parameter Qₒ (water flow rate). The database may be established by modeling, by coupling a particle transport code such as MCNP with a thermohydraulic code.

The inventors have modeled the device shown in FIGS. 1A to 1D so as to obtain various sets of count rates {TC₁ . . . TCᵢ . . . TC_{I}}_{C}_{ₖ}_{,T}_{ₗ}_{,Θ}_{ₘ} for various modeling parameters. They took into account the following modeling parameters:

$${C}_{k} ∈ \{ 0 ppm ; 1800 ppm ; 2600 ppm \} ;$$

$${T}_{l} ∈ \{ 293 K ; 350 K \} ;$$

$${Θ}_{m} ∈ \{ \begin{matrix}350 K & 350 K & 350 K \\ 350 K & 350 K & 293 K \\ 350 K & 293 K & 293 K \\ 293 K & 293 K & 293 K\end{matrix} \}$$

The parameter Θₘ comprises 4 different spatial temperature distributions, each spatial distribution containing one temperature assigned to each elementary layer 21₁, 21₂ and 21=, respectively.

Table 2 shows a ratio between calibration count rates resulting from modeling operations, taking into account various configurations. Each value corresponds to a ratio of count rates, measured by the same detector, in a configuration and in a reference configuration, respectively. The inventors modeled, for each configuration, the numbers of (n,α) reactions per neutron emitted by the source. The count rate, in each configuration, is proportional to this number.

The configurations were as follows:
Configuration 1: Temperature gradient taken into account: 350 K, 350 K, 350 K;
Configuration 2: Temperature gradient taken into account: 350 K, 350 K, 293 K;
Configuration 3: Temperature gradient taken into account: 350 K, 293 K, 293 K;
Configuration 4: Temperature gradient taken into account: 293 K, 293 K, 293 K.
   Configuration 4 was considered as a reference configuration.

Each row of the table corresponds to one concentration value Cₖ. Each column of the table is assigned to one detector among the three modeled detectors.

TABLE 2

| | $\frac{configuration 1}{configuration 4}$ | | | $\frac{configuration 2}{configuration 4}$ | | |
|---|---|---|---|---|---|---|
| | Detec- | Detec- | Detec- | Detec- | Detec- | Detec- |
| Cₖ | tor 1 | tor 2 | tor 3 | tor 1 | tor 2 | tor 3 |
| 0 ppm | 2.40% | 3.08% | 4.20% | 2.39% | 2.27% | 6.74% |
| 1800 ppm | 1.75% | 2.67% | 3.92% | 1.73% | 1.83% | 6.47% |
| 2600 ppm | 1.58% | 2.56% | 3.93% | 1.56% | 1.73% | 6.47% |

| | $\frac{configuration 1}{configuration 4}$ | | |
|---|---|---|---|
| Cₖ | Detector 1 | Detector 2 | Detector 3 |
| 0 ppm | 0.78% | 3.95% | 1.16% |
| 1800 ppm | 0.00% | 3.48% | 0.94% |
| 2600 ppm | −0.18% | 3.35% | 0.98% |

Table 2 shows that, with respect to the reference configuration, the count rate varies differently, between the various detectors, depending on the adopted configuration. The variation, as a function of the detector, in the count rate is a signature of the temperature distribution Θₘ and of the concentration Cₖ.

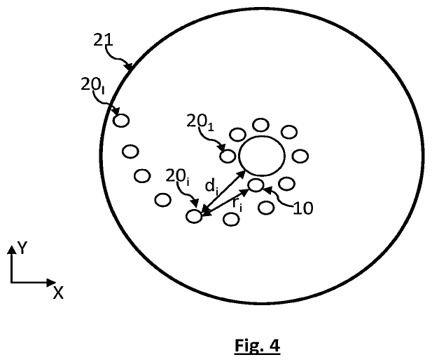

FIG. 4 shows another example of the device, comprising 13 detectors 20ᵢ distributed around a duct 2. In this example, the detectors are distributed in a spiral. In such a configuration, each calibration set and each measurement set forms a 13-tuple comprising 13 count rates.

According to one variant of the invention, each calibration set and each measurement set contains values corresponding to an amount of neutrons not detected, but incident on each detector. It may for example be a question of a number of neutrons per unit time (number of neutrons per second) or a number of neutrons per unit time and unit area (number of neutrons per second and per cm²).

The invention allows a concentration of a neutron-absorbing isotope to be estimated without requiring a temperature measurement, whether it be a question of the water temperature or the temperature at each neutron detector. Temperature is taken into account implicitly, insofar as it results from a confrontation between the calibration sets, forming the calibration database, and the measurement set. Thus, the invention avoids recourse to compensation functions, taking temperature into account. Concentration is determined more accurately, because it is determined taking into account, in the modeled data, the temperature of the fluid, but also the spatial temperature distribution between the various detectors.

Although described with reference to ¹⁰B, the invention may be used to quantify the concentration of other neutron absorbers, +Li for example. In addition, although described with reference to cases where the detectors were boron-lined proportional counters, the invention may be applied to other types of neutron detectors, in particular detectors sensitive to neutrons having been slowed down by a moderating layer: thermal, epithermal or intermediate neutrons.

1. A method for determining a concentration of an isotope in a fluid, the isotope absorbing neutrons, the method comprising:
a) placing a plurality of neutron detectors respectively at various distances from the fluid, the neutron detectors forming a group of detectors;
b) irradiating the fluid by a neutron-emitting source, the neutron-emitting source being placed so that neutrons emitted by the neutron-emitting source pass through the fluid before reaching the neutron detectors;
c) measuring, with each detector of the group of detectors, a quantity representative of an amount of neutrons reaching the detector; and
d) based on the measurements resulting from c), estimating a concentration of the isotope in the fluid,
wherein step d) comprises:
di) taking into account a calibration database, the calibration database containing an estimate of the quantity measured by each detector: for at least one concentration of the isotope in the fluid, and for various spatial temperature distributions through the group of detectors; and
dii) based on the calibration database resulting from di), and on the measurements resulting from c), estimating the concentration of the isotope in the fluid.

2. The method of claim 1, wherein:
step c) comprises forming a measurement set containing the quantities measured by each detector, the size of the measurement set corresponding to the number of detectors in the group of detectors;
step di) comprises, for the or each isotope concentration, and for each spatial temperature distribution, forming a calibration set containing estimates of quantities measured by each neutron detector, the size of each calibration set corresponding to the number of neutron detectors of the group of detectors, each calibration set being associated with a concentration of the isotope and with a spatial temperature distribution across the group of detectors; and
step dii) comprises implementing an optimization algorithm, so as to select, among the various calibration sets, the calibration set closest to the measurement set, the estimated isotope concentration corresponding to the isotope concentration associated with the selected calibration set.

3. The method of claim 2, wherein, in step di), the calibration sets are formed for various temperatures of the fluid, such that each calibration set is associated with one temperature of the fluid.

4. The method of claim 3, wherein:
the group of detectors is placed in an exterior medium at an exterior temperature; and
in step di) the calibration sets are formed for various exterior temperatures, such that each calibration set is associated with one exterior temperature.

5. The method of claim 1, wherein the fluid lies in a duct, the sensors being placed around the duct.

6. The method of claim 5, wherein:
the fluid flows through the duct at a flow rate; and
in step di), the calibration sets are formed for various flow rates of fluid through the duct, such that each calibration set is associated with one flow rate of the fluid.

7. The method, of claim 1, wherein the quantity measured by each detector is:
a count rate of neutrons detected by the detector; or
a number of neutrons incident on the detector per unit time and optionally per unit area.

8. The method, of claim 1, wherein a layer of a moderating material is interposed between each neutron detector and the fluid, the thickness of the layer being different for each detector.

9. The method of claim 8, wherein the layer of the moderating material is divided into elementary layers, each detector lying in one elementary layer, the spatial temperature distribution corresponding to a temperature of each elementary layer.

10. The method of claim 1, wherein the isotope is ¹⁰B or ⁶Li.

11. A device for estimating a concentration of an isotope in a fluid, the fluid lying in an enclosure, the isotope absorbing neutrons, the device comprising:
a neutron-emitting source;
a plurality of neutron detectors, arranged to be respectively placed at various distances from the enclosure, and forming a group of detectors;
the neutron-emitting source being placed so that some of the neutrons emitted by the neutron-emitting source pass through the fluid before reaching the detectors; and
a processing unit connected to the detectors and configured to implement step d) of the method of claim 1 based on measurements, taken by each detector of the group of detectors, of a quantity representative of an amount of neutrons reaching the neutron detector.

12. The device of claim 11, wherein a layer of a moderating material lies around each neutron detector, so that the thickness of the layer, between the detector and the enclosure, is different for each neutron detector.

13. The device of claim 12, wherein the layer is formed from various moderating materials.
